(19) United States
(12) Patent Application Publication
(10) Pub. No.: US 2026/0196468 A1
(43) Pub. Date: Jul. 9, 2026

(54) ELECTRODES FOR ENERGY STORAGE DEVICES

(71) Applicant: NANORAMIC, INC., Woburn, MA (US)

(72) Inventors: Nicolo Brambilla, Brookline, MA (US); Wanjun Ben Cao, Boston, MA (US); Ji Chen, Natick, MA (US); Thomas M. Yu, Brookline, MA (US); Neal Dawson-Elli, Boston, MA (US); Jonathan Wagner, Dorchester, MA (US); Timothy Chu, Auburndale, MA (US); Kristine Maines, Newton, MA (US); Ting Du, Saugus, MA (US); Wonyong (Danny) Shin, Boston, MA (US)

(21) Appl. No.: 19/121,942

(22) PCT Filed: Oct. 18, 2023
(86) PCT No.: PCT/US2023/077150

§ 371 Date: Apr. 17, 2025

Related U.S. Application Data
(60) Provisional application No. 63/417,206, filed on Oct. 18, 2022.

(51) Int. Cl. H01M 4/13; H01G 11/36; H01G 11/38; H01M 4/02; H01M 4/62; H01M 10/0525

(52) U.S. Cl. CPC H01M 4/13; H01M 4/622; H01M 4/625; H01M 10/0525; H01G 11/36; H01G 11/38; H01M 2004/021; H01M 2004/027

(57) ABSTRACT

Disclosed herein is an electrode comprising an active layer comprising a network of high aspect ratio carbon elements defining void spaces within the network; a plurality of electrode active material particles disposed in the void spaces within the network; and a polymeric binder comprising a first polymer which is a polymer comprising an acid functional group or a salt of such acid functional group; a polyamide; or an acrylate polymer, and a second polymer.

### CROSS REFERENCE TO RELATED APPLICATIONS

This application claims the benefit of U.S. Application No. 63/417,206, filed on Oct. 18, 2022, which is incorporated herein by reference in its entirety.

### BACKGROUND OF THE INVENTION

Lithium batteries are used in many products including medical devices, electric cars, airplanes, and consumer products such as laptop computers, cell phones, and cameras. Due to their high energy densities, high operating voltages, and low-self discharges, lithium ion batteries have overtaken the secondary battery market and continue to find new uses in products and developing industries.

Generally, lithium ion batteries (“LIBs” or “LiBs”) comprise an anode, a cathode, and an electrolyte material such as an organic solvent comprising a lithium salt. More specifically, the anode and cathode (collectively, “electrodes”) are formed by mixing either an anode active material or a cathode active material with a binder and a solvent to form a paste or slurry which is then coated and dried on a current collector, such as aluminum or copper, to form a film on the current collector. The anodes and cathodes are then layered or coiled prior to being housed in a pressurized casing containing an electrolyte material, which all together forms a lithium ion battery.

In conventional electrodes, a binder is used with sufficient adhesive and chemical properties such that the film coated on the current collector will maintain contact with the current collector even when manipulated to fit into the pressurized battery casing. Since the film contains the electrode active material, there will likely be significant interference with the electrochemical properties of the battery if the film does not maintain sufficient contact with the current collector. Further, it has been important to select a binder that is mechanically compatible with the electrode active material(s) such that it is capable of withstanding the degree of expansion and contraction of the electrode active material(s) during charging and discharging of the battery.

Accordingly, binders such as cellulosic binder or cross-linked polymeric binders have been used to provide good mechanical properties. However, in conventional electrodes binders selected generally require environmentally unfriendly or toxic solvents for processing.

### SUMMARY OF THE INVENTION

Disclosed herein is an electrode comprising an active layer comprising a network of high aspect ratio carbon elements defining void spaces within the network; a plurality of electrode active material particles disposed in the void spaces within the network; and a binder component comprising a first polymer which comprises an acid functional group or a salt of the acid functional group; a polyamide; or an acrylate polymer, such as in a polyacrylic latex and a second polymer, preferably selected from cellulosic polymers and polyvinylpyrrolidone. The first polymer and the second polymer exist as a blend of polymers in the binder component. The first polymer and the second polymer are not covalently or ionically bonded with each other.

Disclosed herein is an energy storge device comprising a housing; an electrolyte; a first current collector; an anode active material disposed on the first current collector; where the anode active material comprises a network of high aspect ratio carbon elements defining void spaces within the network; a plurality of anode active material particles disposed in the void spaces within the network; and an anode polymeric binder, the anode polymeric binder comprising a first anode polymer comprising at least one a polymer having an acid functional group or a salt of such acid functional group or a water soluble acrylate polymer, such as in a polyacrylic latex and, optionally, a second anode polymer which preferably is a cellulosic polymer; and a second current collector; a cathode active material disposed on the second current collector; where the cathode active material comprises a network of high aspect ratio carbon elements defining void spaces within the network; a plurality of cathode active material particles disposed in the void spaces within the network; where the cathode active material comprises a combination of nickel, manganese and cobalt; and a cathode polymeric binder, the cathode polymeric binder comprising a first cathode polymer comprising at least one of a polymer comprising an acid functional group or a salt of such acid functional group; a polyamide; or an acrylate polymer, such as in a polyacrylic latex and, optionally, a second cathode polymer which preferably comprises polyvinylpyrrolidone provided at least one of the anode polymeric binder and the cathode polymeric binder comprises the second polymer.

### BRIEF DESCRIPTION OF THE DRAWINGS

The following is a brief description of the drawings wherein like elements are numbered alike and which are presented for the purposes of illustrating the exemplary embodiments disclosed herein and not for the purposes of limiting the same.

FIG. 1 is a diagram of an electrode according to various embodiments;

FIG. 2 is a flow chart of a method for making an electrode according to various embodiments;

FIG. 3 is a depiction of the electrode arrangement in pouch cell devices; and

FIG. 4 is a depiction of a schematic cutaway diagram showing aspects of an energy storage device (ESD).

### DETAILED DESCRIPTION

A more complete understanding of the components, processes, and apparatuses disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments. Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

Disclosed herein is an electrolytic cell that comprises a housing that comprises electrodes (an anode and a cathode). The housing comprises an electrolyte that contacts the anode and the cathode. Both of the electrodes (the anode and the cathode) comprises a current collector upon which is disposed an active layer. The active layer may be disposed upon an optional adhesive layer that contacts the electrode.

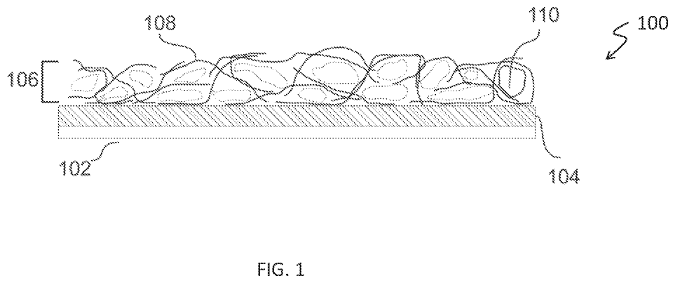

FIG. 1 is a diagram of an electrode (an anode or a cathode) according to various embodiments. In the example shown, electrode 100 is provided. According to various embodiments, electrode 100 comprises current collector 102 and active layer 106. Electrode 100 may optionally include an adhesion layer 104. As an example, adhesion layer 104 comprises a material that promotes adhesion between current collector 102 and active layer 106.

### The Anode

In an embodiment, with regard to the FIG. 1, the electrode (the anode or the cathode) comprises a current collector 102 that is an electrically conductive layer. For example, current collector 102 may be a metal, metal alloy, etc. As another example, current collector 102 is a metal foil. In some embodiments, current collector 102 is an aluminum foil or aluminum alloy foil. In some embodiments, current collector 102 is a copper foil or copper alloy foil. Current collector 102 has a thickness of less than 15 μm. Current collector 102 has a thickness of less than 10 μm. Current collector 102 has a thickness of less than 8 μm. Current collector 102 has a thickness of less than 5 μm. In an embodiment, the current collector 102 has a thickness of 3 to 15 μm. In some preferred embodiments, current collector 102 has a thickness of between about 6 μm and about 8 μm. In some embodiments, current collector 102 is an aluminum foil or an aluminum alloy foil, and current collector 102 has a thickness of about 6 μm.

The active layer 106 used in the anode can comprise a first anode electrically conductive material, optional, a second anode electrically conductive material (the first anode electrically conductive material and the second anode electrically conductive materials are sometimes collectively termed the high aspect ratio carbon elements), an anode binder material, and anode active material. The anode binder material comprises a first polymer, and, preferably a second polymer. Note that as contemplated herein at least one of the anode and cathode comprise two polymers in their binder materials.

The anode active material can comprise a first anode active material and optionally a second anode active material (the first anode active material and the second anode active material are collectively called electrode active material particles). The active layer for the anode (the anode active layer) is manufactured by mixing the first anode electrically conductive material, an optional second anode electrically conductive material, a first anode binder material, an optional second anode binder material, a first anode active material and an optional second anode active material with a solvent to form a mixture. The mixing facilitates dispersion of the first anode electrically conductive material, the second anode electrically conductive material, the first anode active material and the second anode active material in the mixture. The mixture is dried to remove the solvent leaving behind a solid active material. The mixture may be dispersed on the current collector or optionally on the adhesive layer to form the anode active layer. The weight percents of the various ingredients that form the active layer are expressed as a function of the mixture (with the solvent in it) and as a function of the solid anode active layer (without the solvent in it).

At least one of the first anode electrically conductive material and the second anode electrically conductive materials are high aspect ratio carbon elements that comprise a substantially cylindrical network of carbon atoms. The first anode electrically conductive material can comprise a first set of carbon nanotubes or a plurality of bundles of first carbon nanotubes and the second anode electrically conductive material comprises a second set of carbon nanotubes or a plurality of bundles of second carbon nanotubes. The first anode electrically conductive material and the anode second anode electrically conductive materials are sometimes referred to herein (both individually and in combination) as high aspect ratio carbon elements. In an embodiment, the term “high aspect ratio carbon elements” refers to carbonaceous elements having a size in one or more dimensions (the “major dimension(s)”) significantly larger than the size of the element in a transverse dimension (the “minor dimension”).

The first anode electrically conductive material and the second anode electrically conductive materials can form an electrically conducting percolating network that can transmit an electrical current between any two separated points located on a surface of the solid active layer (without the solvent in it). In other words, an electrical current can be transmitted from one surface to an opposing surface of the active layer by virtue of physical contacts or electron hopping between the first anode electrically conductive material and the second anode electrically conductive materials in the anode active layer. The percolating network comprises voids between the high aspect ratio carbon elements that house the anode active materials (the first and second anode active materials).

In some embodiments, the anode active layer includes: (i) a network of high aspect ratio carbon elements defining void spaces within the network, (ii) a plurality of electrode active material particles disposed in the void spaces within the network, and (iii) a polymeric binder, anode polymeric binder, the anode polymeric binder comprising a first polymer comprising at least one a polymer having an acid functional group or a salt of such acid functional group or a water soluble acrylate polymer, such as in a polyacrylic latex and a second polymer which preferably is a cellulosic polymer. The first polymer and the second polymer are blended together to form the polymeric binder. The first polymer and the second polymer are not covalently bonded or ionically bonded to one another. A copolymer (a third polymer) that facilitates a blending of the first polymer with the second polymer may be used to compatibilize the first polymer with the second polymer. The third polymer (the copolymer) may comprise the first polymer and the second polymer bonded to each other. The third polymer therefore functions as a surfactant to compatibilize the first polymer with the second polymer.

The first anode electrically conductive material can comprise a high aspect ratio carbon element that is bounded by a single carbon wall (SWCNTs). In an embodiment, the first anode electrically conductive material comprises single wall carbon nanotubes. The single wall carbon nanotubes have an outer diameter of 0.5 to 5.0 nanometers, preferably 1.0 to 3.5 nanometers. In an embodiment, the single wall carbon nanotubes have an aspect ratio (length to diameter ratio) greater than about 2.0, preferably greater than 5.0, preferably greater than 10.0, greater than 50 and more preferably greater than 100. In an exemplary embodiment, the single wall carbon nanotubes have an average aspect ratio of 5 to 200.

In an embodiment, the single wall carbon nanotubes can have a length greater than 6 nanometers, preferably greater than 10 nanometers, preferably greater than 15 nanometers, preferably greater than 30 nanometers, preferably greater than 50 nanometers, more preferably greater than 100 nanometers, preferably greater than 1 micrometer, preferably greater than 5 micrometers, preferably greater than 10 micrometers, and more preferably greater than 15 micrometers up to at least 200 micrometers. In an exemplary embodiment, the single wall carbon nanotubes have an average length of 10 nanometers to 20 micrometers, preferably 20 nanometers to 15 micrometers.

The single wall carbon nanotubes are present in the mixture (the mixture comprises the first anode electrically conductive material, the second anode electrically conductive material, the first anode binder material, the second anode binder material, the first and second anode active material and a solvent) in an amount of 0.1 to 0.3 weight percent, preferably 0.15 to 0.25 weight percent based on the total weight of the mixture.

The single wall carbon nanotubes are present in the solid anode active material (the solid active material comprises the first anode electrically conductive material, the second anode electrically conductive material, the first anode binder material and the second anode binder material without the solvent) in an amount of 0.2 to 0.6 wt %, preferably 0.3 to 0.5 wt %, based on the entire weight of the solid anode active material.

The second anode electrically conductive material can comprise a high aspect ratio carbon element that is bounded by multiple carbon walls. In an embodiment, the second anode electrically conductive material comprises multiwall carbon nanotubes (MWNTs). The number of carbon walls in the multiwall carbon nanotubes may be 2 or more, 5 or more, 10 or more, 50 or more. According to various embodiments, the multi-wall carbon nanotubes comprise an average of between 3 layers to 15 layers. In some embodiments, the multi-wall carbon nanotubes comprise an average of between 4 layers to 12 layers. In some embodiments, the multi-wall carbon nanotubes comprise an average of between 5 layers to 10 layers. In some embodiments, the multi-wall carbon nanotubes comprise an average of between 6 layers to 7 layers. In some embodiments, the multi-wall carbon nanotubes comprise at least 6 layers on average.

According to various embodiments, the active layer 106 comprises multi-wall carbon nanotubes and single-wall carbon nanotubes. The multi-wall carbon nanotubes swell more than single-wall carbon nanotubes when wetted with an electrolyte in an energy storage device in which electrode 100 is located. In some embodiments, the multi-wall carbon nanotubes swell at least 15% more than single-wall carbon nanotubes when wetted with an electrolyte in an energy storage device in which electrode 100 is located. For example, a length of the multi-wall carbon nanotubes expands at least 15% more than a length of the single-wall carbon nanotubes when wetted with the electrolyte. In some embodiments, the multi-wall carbon nanotubes swell at least 25% more than single-wall carbon nanotubes when wetted with an electrolyte in an energy storage device in which electrode 100 is located. For example, a length of the multi-wall carbon nanotubes expands at least 25% more than a length of the single-wall carbon nanotubes when wetted with the electrolyte. In some embodiments, the multi-wall carbon nanotubes swell at least 50% more than single-wall carbon nanotubes when wetted with an electrolyte in an energy storage device in which electrode 100 is located. For example, a length of the multi-wall carbon nanotubes expands at least 50% more than a length of the single-wall carbon nanotubes when wetted with the electrolyte. In some embodiments, the multi-wall carbon nanotubes swell up to 50% when wetted (e.g., a length of the multi-wall carbon nanotubes is 50% larger after wetting with an electrolyte, and/or a diameter of the multi-wall carbon nanotubes is 50% larger after wetting, etc.).

According to various embodiments, three-dimensional network of high aspect ratio carbon elements 108 comprises carbon nanotubes, and the carbon nanotubes are only multi-wall carbon nanotubes and/or fragment of carbon nanotubes. For example, three-dimensional network of high aspect ratio carbon elements 108 does not include single-wall carbon nanotubes or fragments of single-wall carbon nanotubes. According to various embodiments, three-dimensional network of high aspect ratio carbon elements 108 comprises at least 99% carbon by weight. In some embodiments, three-dimensional network of high aspect ratio carbon elements 108 comprises an electrically interconnected network of carbon elements exhibiting connectivity above a percolation threshold and wherein the network defines one or more highly electrically conductive pathways having a length greater than 100 μm. The percolation threshold is one where the conducting elements contact one another to provide an electrically conducting network measured across any two points on any surface of the network.

The multiwall carbon nanotubes have an outer diameter of 2.0 to 50 nanometers, preferably 5.0 to 40 nanometers, and more preferably 6 to 10 nanometers. In an embodiment, the multiwall carbon nanotubes have an aspect ratio (length to diameter ratio) greater than 5.0, preferably greater than 10.0, greater than 50 and more preferably greater than 100, and more preferably greater than 500.

In an embodiment, the multiwall carbon nanotubes have a length greater than 10 nanometers, preferably greater than 15 nanometers, preferably greater than 30 nanometers, preferably greater than 50 nanometers, preferably greater than 100 nanometers, preferably greater than 500 nanometers, preferably greater than 1 micrometer, preferably greater than 5 micrometers, preferably greater than 10 micrometers, and more preferably greater than 15 micrometers. In an exemplary embodiment, the multiwall carbon nanotubes have an average length of 10 nanometers to 20 micrometers, preferably 20 nanometers to 15 micrometers.

According to various embodiments, the electrode comprises multiwall carbon nanotubes that are relatively longer in comparison to multiwall carbon nanotubes comprised in related art electrodes. The use of relatively longer multiwall carbon nanotubes in electrodes is found to have beneficial mechanical and/or electrical properties. For example, multiwall carbon nanotubes provide relatively good power at low densities. As another example, shorter multiwall carbon nanotubes generally do not swell (e.g., expand) as much as longer multiwall carbon nanotubes. As such use of shorter multiwall carbon nanotubes loses (or reduces) some of the beneficial properties associated with swelling of the carbon nanotubes. As an extreme example, carbon black does not exhibit swelling because carbon black is merely particles of carbon without entanglement such as the entanglement exhibited by a set of multiwall carbon nanotubes. An indication that a length of a certain amount of multiwall carbon nanotubes have a length exceeding a threshold length and thus have sufficient swelling properties is an observation during a calendaring process—a relatively larger amount of pressure or effort to calendar the slurry in connection with applying to the foil is indicative that the collective swelling (e.g., an average swelling) of the multiwall carbon nanotubes in the active layer will satisfy a certain performance threshold. However, multiwall carbon nanotubes are generally difficult to process. The processing of the multiwall carbon nanotubes in connection with preparing/forming the active layer and/or electrode is gentler than processes for related art electrodes. As such, the processes according to various embodiments maintain longer multiwall carbon nanotubes (e.g., less multiwall carbon nanotubes are crushed, fragmented, broken, etc.). In some embodiments, the active layer of the electrode comprises a set of multiwall carbon nanotubes having an average length that is more an average length of the multiwall carbon nanotubes in related art electrodes. According to various embodiments, a distribution of lengths of the set of multiwall carbon nanotubes is skewed towards a nominal length a multiwall carbon nanotube. As an example, the nominal length of a multiwall carbon nanotube is about 16 microns. For example, the multiwall carbon nanotubes are processed and/or applied in a manner that reduces or minimizes fracturing or breaking of multiwall carbon nanotubes. The lengths of the multiwall carbon nanotubes in the network of high aspect ratio carbon elements are generally the nominal length of the multiwall carbon nanotubes, or a length of such the multiwall carbon nanotubes tend to be more heavily skewed to the nominal length. In some embodiments, at least 75% of the multiwall carbon nanotubes within the network of high aspect ratio carbon elements are within 10% of the nominal length (e.g., between 13.4 microns to about 15 microns). In some embodiments, at least 75% of the multiwall carbon nanotubes within the network of high aspect ratio carbon elements have a length of at least 12 microns. In some embodiments, at least 75% of the multiwall carbon nanotubes within the network of high aspect ratio carbon elements have a length of at least 13 microns. In some embodiments, at least 50% of the multiwall carbon nanotubes within the network of high aspect ratio carbon elements are within 10% of the nominal length (e.g., between 13.4 microns to about 15 microns). In some embodiments, at least 50% of the multiwall carbon nanotubes within the network of high aspect ratio carbon elements have a length of at least 12 microns. In some embodiments, at least 50% of the multiwall carbon nanotubes within the network of high aspect ratio carbon elements have a length of at least 8 microns. In some embodiments, at least 50% of the multiwall carbon nanotubes within the network of high aspect ratio carbon elements have a length of at least 13 microns.

According to various embodiments, a distribution of lengths of the set of multiwall carbon nanotubes is skewed towards a nominal length a multiwall carbon nanotube. For example, the multiwall carbon nanotubes are processed and/or applied in a manner that reduces or minimizes fracturing or breaking of multiwall carbon nanotubes. The lengths of the multiwall carbon nanotubes in the network of high aspect ratio carbon elements are generally the nominal length of the multiwall carbon nanotubes, or a length of such the multiwall carbon nanotubes tend to be more heavily skewed to the nominal length.

In some embodiments, at least 75% of the multiwall carbon nanotubes within the network of high aspect ratio carbon elements are within 10% of the nominal length (e.g., between 13.4 micrometers to about 15 micrometers). In some embodiments, at least 75% of the multiwall carbon nanotubes within the network of high aspect ratio carbon elements have a length of at least 12 micrometers. In some embodiments, at least 75% of the multiwall carbon nanotubes within the network of high aspect ratio carbon elements have a length of at least 13 micrometers. In some embodiments, at least 50% of the multiwall carbon nanotubes within the network of high aspect ratio carbon elements are within 10% of the nominal length (e.g., between 13.4 micrometers to about 15 micrometers). In some embodiments, at least 50% of the multiwall carbon nanotubes within the network of high aspect ratio carbon elements have a length of at least 12 micrometers. In some embodiments, at least 50% of the multiwall carbon nanotubes within the network of high aspect ratio carbon elements have a length of at least 13 micrometers.

The multiwall carbon nanotubes are present in the mixture (the mixture comprises the first anode electrically conductive material, the second anode electrically conductive material, the first anode binder material, the second anode binder material and a solvent) in an amount of 0.3 to 1.0 weight percent, preferably 0.4 to 0.9 weight percent based on the total weight of the mixture.

The multiwall carbon nanotubes are present in the solid anode active material (the solid active material comprises the first anode electrically conductive material, the second anode electrically conductive material, the first anode binder material and the second anode binder material without the solvent) in an amount of 0.8 to 2.6 wt %, preferably 1.0 to 1.8 wt %, based on the entire weight of the solid anode active material.

In an embodiment, the second anode electrically conductive material is present in the mixture or in the solid anode active material layer in an amount that is at least twice the amount of the first electrically conductive material, based on the weight of the respective conductive materials. In an embodiment, the ratio of the weight of the multiwall carbon nanotubes to the weight of the single wall carbon nanotubes in the mixture or in the solid active material layer is at least 2:1.

The first anode binder comprises a first polymer that is at least soluble in water, an alcohol, or a combination thereof. Other solvents may be used with the water or alcohol. These will be detailed later.

Suitable first polymers can be obtained from the polymerization of monomers having the structure (1):

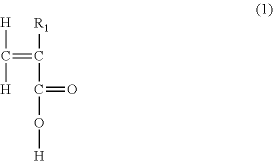

where R¹ is a hydrogen or an alkyl group having 1 to 10 carbon atoms. A preferred alkyl group has 2 to 5 carbon atoms. Examples of the first polymers obtained from the polymerization of monomers having the structure (1) include polyacrylic acid, polymethacrylic acid, or a combination thereof. The first polymers have a molecular weight of 5,000 to 2,000,000 grams per mole, preferably 10,000 to 1,000,000 grams per mole and may be thermoplastic or crosslinked materials.

The first polymer of the anode binder can be formed from a latex (i.e., a dispersion of polymer particles in solvent). Preferably, the solvent in the latex is water, alcohol, or a combination thereof. The first polymer of the anode binder can be a polyacrylic acid or a salt thereof. The first anode polymer can be a homopolymer or a copolymer.

The first anode binder may be modified by blending the first polymer (obtained from the polymerization of monomers having the structure (1)) with the second polymer. It is desirable for the blend of the first polymer with the second polymer to also be soluble in water, alcohol, or a combination thereof. It is also contemplated that one of or a portion of one of the first or second polymers be combined with the electrically conductive material in a solvent (e.g., water, alcohol, or a combination thereof) to form an initial slurry. The initial slurry can then be combined with the active material and the remaining polymer material. The second anode polymer can comprise an organic polymer that is selected from a wide variety of thermoplastic polymers. The second polymer can comprise an oligomer, a homopolymer, a copolymer, a block copolymer, an alternating block copolymer, a random polymer, a random copolymer, a random block copolymer, a graft copolymer, a star block copolymer, a dendrimer, a polyelectrolyte (polymers that have some repeat groups that contain electrolytes), a polyampholyte (a polyelectrolyte having both cationic and anionic repeat groups), an ionomer, or the like, or a combination comprising at last one of the foregoing organic polymers. The second polymer has a number average molecular weights greater than 10,000 grams per mole, preferably greater than 20,000 g/mole and more preferably greater than 50,000 g/mole.

Examples of organic polymers that include the second polymer includes polyacetals, polyacrylics, polycarbonates, polyalkyds, polystyrenes, polyolefins, polyesters, polyamides, polyaramides, polyamideimides, polyarylates, polyurethanes, epoxies, phenolics, silicones, polyarylsulfones, polyethersulfones, polyphenylene sulfides, polysulfones, polyimides, polyetherimides, polytetrafluoroethylenes, polyetherketones, polyether ether ketones, polyether ketone ketones, polybenzoxazoles, polyoxadiazoles, polybenzothiazinophenothiazines, polybenzothiazoles, polypyrazinoquinoxalines, polypyromellitimides, polyguinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polycarboranes, polyoxabicyclononanes, polydibenzofurans, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, polypropylenes, polyethylenes, polyethylene terephthalates, polyvinylidene fluorides, polysiloxanes, or a combination thereof.

In a preferred embodiment, the second polymer is preferably soluble in water, alcohol, or a combination thereof. The second polymer may be a polyacrylamide, a polyamide, a polyethylene glycol, a polyvinyl alcohol, polyvinylpyrrolidone, cellulosic polymers, acrylic/maleic copolymers, polyoligosaccharides, or a combination thereof. In one preferred embodiment the second polymer of the anode polymer is a cellulosic polymer.

The first polymer of the anode binder can be a derivative of the first polymer obtained by polymerizing the monomer of structure (1). In an embodiment, the derivative may comprise a salt of the first polymer. Examples of the salt of the first polymer include a tetradecyldimethylbenzylammonium salt of polyacrylic acid, benzethonium salt of polyacrylic acid, or other salts of polyacrylic acid.

The first anode polymer can be present in an amount of 2 to 3 weight percent (wt %), preferably 2.1 to 2.9 wt %, based on the total weight of the mixture (where the mixture comprises the first anode electrically conductive material, the second anode electrically conductive material, the first anode binder material, the second anode binder material, first and second anode active materials and a solvent). The first anode polymer can be present in an amount of 5 to 9 wt %, preferably 6 to 8 wt %, based on the total weight of the solid active layer.

The second anode polymer present in the active layer is preferably also a water soluble polymer. The second anode binder is chemically different from the first anode polymer. In an embodiment, the second anode polymer can be a water soluble, naturally occurring polymer. Examples of naturally occurring polymers for use as the second anode binder includes cellulose and cellulose derivatives (e.g., hydroxymethylcellulose, hydroxyethylcellulose, hydroxypropylcellulose, hydroxypropyl methylcellulose, carboxymethyl cellulose (CMC), sodium carboxymethyl cellulose, cellulose acetate, cellulose diacetate, cellulose triacetate, cellulose propionate, cellulose acetate butyrate, and cellulose ethers like ethyl cellulose, or the like, or a combination thereof), sugars (glucose, sucrose, lactose, galactose, fructose, mannitol, sorbitol, or a combination thereof), ionic complexes of celluloses (gums (e.g., acacia, alginate, carrageenan, guar, karaya, pectin, tragacanth, xanthan, or the like, or a combination thereof).

Other examples of the second anode polymer include polyethylene oxide (PEO), a polyether, derivatives of poly(ethylene glyol) (PEG), a fluorine-containing polymer particularly poly(vinylidene difluoride) (PVDF), polyurethane (PU), polytetrafluoroethylene (PTFE), an alginate (Alg), renatured DNA/Alg, Alg-catechol, polyacrylic acid (PAA)-catechol, carboxymethyl chitosan, guar gum, agarose, konjac glucomannan, carboxymethylated gellan gum, PDA-PAA-PEO, Pectin/PAA, partially lithiated PAA and Nafion, sequence-defined peptoids, PMDOPA, branched PAA, NaPAA-g-CMC, CS-g-PAANa, PVA-g-PAA, GC-g-LiPAA, PVDF-g-PAA, branched PAA-PEG, CS-g-PANI, hyperbranched β-cyclodextrin, double-helical native xanthan gum, Li-Nafion, PAA/CMC, crosslinked PAA/PVA, glycerol-crosslinked PEDOT: PSS, maleic anhydride (MAH) crosslinked corn starch, MAH crosslinked CMC, crosslinked natural GG polymer, crosslinked chitosan, CS-CG+GA, crosslinked dextrin, crosslinked CMC-PEG, crosslinked hyperbranched PEI, crosslinked PAM hydrogel, crosslinked PU elastomer, crosslinked PVA-PEI, TMM functionalized PVA network, a polymer comprising a polyamide (e.g., a nylon), a functionalized polyamide, a copolymer of PEO and a polyamide, self-healing polymers, PAA-Upy supramolecular, self-healing PAU-g-PEG, Ca²⁺ crosslinked SA hydrogel, (Fe³⁺) crosslinked (PANa_{0.8}Fe_{y}), Sn⁴⁺ crosslinked PEDOT: PSS, PAA-PEG-PBI, crosslinked CMC-CPAM, metallopolymer, Si@Fe³⁺-PDA-PAA, β-CDp/6 AD, Slide-ring PR-PAA, conductive PFFOMB, PEG grafted PFP, PF-COONa, PFPQ-COONa, Pyrene-based (PPyE), pyrene-based (PPyMAA), pyrene-based (PPyMADMA), PANI, FA dopped PEDOT: PSS, stretchable conductive glue, poly(phenanthrenequinone), cyclized-PAN, PAA-P (HEA-co-DMA), PEDOT: PSS/PEO/PEI, PAA/PVA+ elastic gel polymer electrolyte, PAA+BFPU, a hybrid of PU and poly(acrylic acid) (PAA), a co-polymer of any subset of the foregoing.

In a preferred embodiment, the second anode polymer comprises or consists of carboxymethyl cellulose (CMC).

The second anode polymer can be present in an amount of 0.1 to 1.0 wt %, preferably 0.2 to 0.6 wt %, based on the total weight of the mixture. The second anode binder can be present in an amount of 0.2 wt % to 2 wt %, preferably 0.4 to 1.6 wt %, based on the total weight of the solid active layer.

In an embodiment, if the first anode polymer and the second anode polymer are not mutually compatible, they can be blended together with a third polymer that comprises a copolymer having two components-one component (a first component) of which is compatible with the first anode polymer and a second component which is compatible with the second anode polymer.

The anode active materials can be located in voids encompassed by the electrically conductive network formed by the high aspect ratio carbon elements. The anode active materials can comprise a first anode active material. The first anode active material can comprise silicon monoxide (SiOx) due to its higher capacity and longer cycle life than those of graphite and silicon respectively. In an embodiment, the first anode active material comprises carbon coated silicon monoxide. In an embodiment, the carbon comprises graphite or another carbonaceous material such as carbon nanotubes, carbon black, or a combination thereof. The use of a carbon coated silicon monoxide provides the storage device with a high-capacity anode that exhibits greater than 90% initial coulombic efficiency (ICE).

The first anode active material is present in the mixture (where the mixture is the first anode electrically conductive material, a second anode electrically conductive material, a first anode binder material, a second anode binder material, a first anode active material, a second anode active material and the solvent) in an amount of 25 to 33 wt %, preferably 26 to 31 wt %, based on the total weight of the mixture.

The first anode active material is present in the anode active layer in an amount of 67 to 95 wt %, based on the total weight of the anode active layer.

The anode active material can comprise a second anode active material. The second anode active material can comprise graphite. Graphite may be natural graphite or artificial graphite. In a preferred embodiment, the graphite is artificial graphite. The graphite is added in particulate form (powder form). In an embodiment, the graphite may be intercalated.

The graphite may be added in amounts of 0.75 to 6 wt %, preferably 1 to 5 wt %, based on a total weight of the mixture. The graphite may be added in amounts of 2.5 to 18 wt %, preferably 4 to 16 wt %, based on a total weight of the solid active layer.

In an embodiment, the SiOx/Graphite anode (SiOx content=~20 wt. %) based electrodes and their material synthesis and manufacturing method: mass loading 8-14 mg/cm², reversible specific capacity≥550 mAh/g. Long life performance specially for SiOx/Graphite anode based Li-ion based electrolyte for battery: from −30 to 60° C. High-energy, high-power density, and long cycle life Ni-rich NMC cathode/SiOx+Graphite/Carbon+based Li-ion battery pouch cells: capacity≥5 Ah, Specific Energy≥300 Wh/kg, Energy Density≥800 Wh/L, with a cycle life of more than 500 cycles under 1 C-Rate charge-discharge, and ultra-high-power fast charge-discharge C-Rate (Up to 5 C-Rate) capabilities.

The mixture for manufacturing the anode active layer further contains a solvent. The solvent is preferably one that is used to disperse the first anode polymer, the second anode polymer, the first anode electrically conductive material and the second conductive material to form the mixture. The mixture is then disposed on the current collector to form the active layer.

Suitable solvents are water, alcohol, or a combination thereof. Examples of alcohol are ethanol, methanol, propanol, butyl alcohol, ethylene glycol, propylene glycol, or a combination thereof. In addition to water and alcohol, other solvents may be added to facilitate solubilization and/or dispersion of the polymer. Other solvents include polar solvents, non-polar solvents, and the like. The addition of other solvents should preferably not change the solubility of the polymer in the water or alcohol. Liquid aprotic polar solvents such as propylene carbonate, ethylene carbonate, butyrolactone, acetonitrile, benzonitrile, nitromethane, nitrobenzene, sulfolane, dimethylformamide, N-methylpyrrolidone, or the like, or combinations thereof may be added to water or alcohol for dissolution of the polymer. Polar protic solvents such acetonitrile, nitromethane, acetone, dimethyl sulfoxide, dimethylformamide, or the like, or a combination thereof may be used. Other non-polar solvents such a benzene, toluene, methylene chloride, carbon tetrachloride, hexane, diethyl ether, tetrahydrofuran, or the like, or a combination thereof may also be used. Co-solvents comprising at least one aprotic polar solvent and at least one non-polar solvent may also be utilized to modify the solubilization power of the solvent.

When water and alcohol are used as the solvents for the active layer (used in the anode) the ratio of water to alcohol is 80:20 to 95:5, preferably 88:12 to 92:8. In an exemplary embodiment, the ratio of water to alcohol is 90:10.

The solvent is present in an amount of 60 to 95 wt %, preferably 65 to 90 wt %, based on the total weight of the mixture. The solid active layer preferably is free of solvent (water and alcohol).

The active layer 106 has an average thickness of between 20 microns and 200 microns. In some embodiments, active layer 106 has an average thickness of 20 microns to 30 microns. In some embodiments, active layer 106 has an average thickness of about 100 microns.

According to various embodiments, the active layer 106 expands (e.g., swells) less than 10% when wetted with an electrolyte. For example, the thickness of active layer 106 (after wetting with an electrolyte) is less than 110% of the thickness of active layer 106 in the absence of the electrolyte.

The mixture comprising the binders, the electrically conductive materials and the solvent may also contain additional additives such as dispersants, surfactants, or the like, or a combination thereof. Surfactants and dispersants are used to provide a surfactant layer on the high aspect ration carbon elements.

The surface treatment may include a surfactant layer that is bonded to the high aspect ratio carbon elements 108 and comprises a plurality of surfactant elements each having a hydrophobic end and a hydrophilic end, wherein the hydrophobic end is disposed proximal a surface one of the high aspect ratio carbon elements 108 and the hydrophilic end is disposed distal said surface one of the high aspect ratio carbon elements 108. In some embodiments, surface treatment comprises at least part of the polymeric additive. In some embodiments, the surface treatment comprises a material which is soluble in a solvent having a boiling point less than 200° C. In some embodiments, the surface treatment comprises a material which is soluble in a solvent having a boiling point less than 185° C.

According to various embodiments, active layer 106 comprises a a polymer that can function as a dispersant. The dispersant may be selected based on a compatibility with water and/or alcohol such as ethanol. In some embodiments, the dispersant is a water-soluble polymer. In some embodiments, the dispersant corresponds to, or comprises, polyvinylpyrrolidone (PVP). The PVP used in the dispersant may be a PVP having a relatively high molecular weight.

According to various embodiments, the active layer 106 comprises about 25% of dispersant by weight of active layer 106. In some embodiments, an amount of dispersant comprised in active layer 106 is between 10% to 50% of active layer 106 by weight. In some embodiments, an amount of dispersant comprised in active layer 106 is between 15% to 40% of active layer 106 by weight. In some embodiments, an amount of dispersant comprised in active layer 106 is between 20% and 30% of active layer 106 by weight.

In various embodiments, the surfactant used to form the surface treatment includes one or more of the following: hexadecyltrimethylammonium hexafluorophosphate (CTAP), hexadecyltrimethylammonium tetrafluoroborate (CTAB), hexadecyltrimethylammonium acetate, hexadecyltrimethylammonium nitrate, hocamidopropyl betaine, N-(cocoalkyl)-N,N,N-trimethylammonium methyl sulfate, cocamidopropyl betaine, or the like, or a combination thereof.

### The Cathode

The cathode comprises one or more polymeric binders (cathode polymeric binders), one or more active materials and an electrically conductive material. The one or more polymeric binders, one or more active materials and the electrically conductive material are blended with a solvent to form a cathode mixture. The cathode mixture is then disposed on a current collector (typically a metal) and dried to form a solid cathode active layer.

As noted above the polymeric binder for at least one of the anode and the cathode comprises two polymers. Thus, the cathode polymeric binders (used in the cathode) can comprise a first cathode polymer which comprises an acid functional group or a salt of such acid functional group; a polyamide; or an acrylate polymer, such as in a polyacrylic latex. r. The cathode polymeric binders (used in the cathode) preferably also includes a second cathode polymer. The second cathode polymer preferably comprises polyvinylpyrollidone (PVP).

The polyamides (used in the first cathode polymer) can include aliphatic polyamides, aromatic polyamides, or a combination thereof. In one embodiment, the polyamides include a generic family of resins known as nylons, characterized by the presence of an amide group (—C(O) NH—). Any amide-containing polymers can be employed, individually or in combination: Nylon-6 and nylon-6,6 are suitable polyamide resins available from a variety of commercial sources. Other polyamides, however, such as nylon-4, nylon-4,6 (PA 46), nylon-12, nylon-6,10, nylon-6,9, nylon-6,12, nylon-9T, copolymer of nylon-6,6 and nylon-6, nylon 610 (PA610), nylon 11 (PA11), nylon 12 (PA 12), nylon 6-3-T (PA 6-3-T), polyarylamid (PA MXD 6), polyphthalamide (PPA) and/or poly-ether-block amide, and others such as the amorphous nylons, may also be useful. Mixtures of various polyamides, as well as various polyamide copolymers, are also useful.

The polyamides can be obtained by a number of well-known processes such as those described in U.S. Pat. Nos. 2,071,250; 2,071,251; 2,130,523; 2,130,948; 2,241,322; 2,312,966; and 2,512,606. Nylon-6, for example, is a polymerization product of caprolactam. Nylon-6,6 is a condensation product of adipic acid and 1,6-diaminohexane. Likewise, nylon 4,6 is a condensation product between adipic acid and 1,4-diaminobutane. Besides adipic acid, other useful diacids for the preparation of nylons include azelaic acid, sebacic acid, dodecane diacid, as well as terephthalic and isophthalic acids, and the like. Other useful diamines include m-xylyene diamine, di-(4-aminophenyl) methane, di-(4-aminocyclohexyl) methane; 2,2-di-(4-aminophenyl) propane, 2,2-di-(4-aminocyclohexyl) propane, among others. Copolymers of caprolactam with diacids and diamines are also useful.

Polyamides are generally derived from the polymerization of organic lactams having from 4 to 12 carbon atoms. In one embodiment, the lactams are represented by the formula (I)

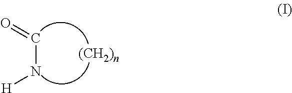

wherein n is 3 to 11. In one embodiment, the lactam is epsilon-caprolactam having n equal to 5.
Polyamides may also be synthesized from amino acids having from 4 to 12 carbon atoms. In one embodiment, the amino acids are represented by the formula (II)

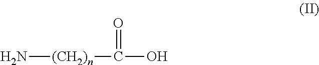

wherein n is 3 to 11. In one embodiment, the amino acid is epsilon-aminocaproic acid with n equal to 5. Polyamides may also be polymerized from aliphatic dicarboxylic acids having from 4 to 12 carbon atoms and aliphatic diamines having from 2 to 12 carbon atoms. In one embodiment, the aliphatic diamines are represented by the formula (III)

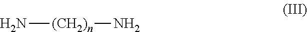

wherein n is about 2 to about 12. In one embodiment, the aliphatic diamine is hexamethylenediamine (H₂N(CH₂)(NH₂). In one embodiment, the molar ratio of the dicarboxylic acid to the diamine is from 0.66 to 1.5. Within this range it is generally beneficial to have the molar ratio be greater than or equal to 0.81. In another embodiment, the molar ratio is greater than or equal to 0.96. In yet another embodiment, the molar ratio is less than or equal to 1.22. In still another embodiment, the molar ratio is less than or equal to 1.04. Examples of polyamides that are useful in the present invention include nylon 6, nylon 6,6, nylon 4,6, nylon 6, 12, nylon 10 or combinations including at least one of the foregoing polyamides.

The acid functional cathode polymer can comprise polyacrylic acid, polyacrylic acid copolymers, or combinations thereof which are listed and described above and will not be repeated here again in the interests of brevity.

Acrylate copolymers comprise a polyacrylate or a polymethacrylate that is copolymerized with another polymer that does not have the exact chemical structure of the polyacrylate or the polymethacrylate. Acrylates may be obtained from the polymerization of monomers having the following structure represented by the formula (4) or by the formula (5):

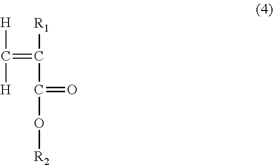

where R₁ is a hydrogen or an alkyl group having 1 to 10 carbon atoms and R₂ is a C₁₋₁₀ alkyl, a C₃₋₁₀ cycloalkyl, or a C₇₋₁₀ aralkyl group. In an embodiment, the polyacrylate comprises a fluorine atom and is obtained by the polymerization of a monomer that has at least one fluorine atom substituent and that has a structure represented by the formula (5):

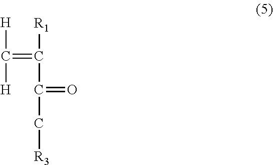

where R₁ is a hydrogen or an alkyl group having 1 to 10 carbon atoms and R₃ is a C₂₋₁₀ fluoroalkyl group. Suitable polymeric acrylates include polyacrylate, polymethylacrylate, polymethylmethacrylate, polybutylacrylate, or a combination thereof.

In an embodiment, the polyacrylic acid (detailed above) is copolymerized with a polyamide (detailed above) or with one of the polyacrylates (detailed above) to form the first cathode polymeric binder.

The first cathode polymeric binder is present in an amount of 0.1 to 0.4 wt %, preferably 0.15 to 0.375 wt %, based on the weight of the cathode mixture (which includes the cathode polymeric binders (the first and second cathode polymeric binders), the cathode active material, the cathode conductive material and the solvent). The first cathode polymeric binder is present in the cathode active layer in an amount of 0.2 to 0.5 wt %, preferably 0.25 to 0.45 wt %, based on the total weight of the cathode active layer.

The cathode active layer comprises a preferably comprises a second cathode polymer binder which comprises polyvinylpyrollidone (PVP). The PVP may function as a dispersant for the cathode active material and the cathode electrically conductive filler in addition to serving a second cathode polymeric binder.

The second cathode polymeric binder is present in an amount of 0.1 to 0.4 wt %, preferably 0.15 to 0.375 wt %, based on the weight of the cathode mixture (which includes the cathode polymeric binders (the first and second cathode polymeric binders), the cathode active material, the cathode conductive material and the solvent). The second cathode polymeric binder is present in the cathode active layer in an amount of 0.2 to 0.5 wt %, preferably 0.25 to 0.45 wt %, based on the total weight of the cathode active layer.

The cathode mixture comprises an electrically conductive material. This electrically conductive material can comprise high aspect ratio carbon elements. The high aspect ratio carbon elements include single wall carbon nanotubes, multiwall carbon nanotubes, or combinations thereof as discussed above. For example, the cathode electrically conductive material can comprise multiwall nanotubes form a percolating network with voids that are encapsulated by the multiwall carbon nanotubes. The voids contain the cathode active material. The multiwall carbon nanotubes are detailed above and will not be detailed again in the interests of brevity. The multiwall carbon nanotubes are present in an amount of 0.1 to 0.5 wt %, preferably 0.2 to 0.4 wt %, based on the weight of the cathode mixture (which includes the cathode polymeric binders (the first and second cathode polymeric binders), the cathode active material, the cathode conductive material and the solvent). The multiwall carbon nanotubes are present in the cathode active layer in an amount of 0.2 to 0.7 wt %, preferably 0.3 to 0.6 wt %, based on the total weight of the cathode active layer.

The cathode active material can include a nickel-rich combination of nickel, manganese, and cobalt. Lithium-Nickel-Manganese-Cobalt-Oxide (LiNiMnCoO₂), abbreviated as NMC delivers strong overall performance, excellent specific energy, and the lowest self-heating rate of all mainstream cathode powders. The NMC powder may comprise nickel in an amount of 20 to 40 wt %, manganese in an amount of 20 to 40 wt % and cobalt in an amount of 20 to 40 wt %, based on a total weight of the NMC blend. While the term “NMC powder” can refer to a variety of blends, it is desirable to use a blend that comprises 33 wt % nickel, 33 wt % manganese and 33 wt % cobalt. This blend, sometimes referred to as 1-1-1 is useful for applications that use frequent cycling (automotive, energy storage) due to the reduced material cost resulting from lower cobalt content.

As noted above, the cathode active material is housed in the network of high aspect ratio active materials present in the cathode active layer. The cathode active material is present in amount of 55 to 75 wt %, preferably 60 to 70 wt %, based on a total weight of the cathode mixture (the mixture used to manufacture the cathode active layer which contains the cathode polymeric binders (the first and second cathode polymeric binders), the cathode active material, the cathode conductive material and the solvent). The cathode active material is present in the cathode active layer (which is devoid of the solvent) in an amount of 95 to 98.5 wt %, based on a total weight of the cathode active layer.

In an embodiment, the cathode polymeric binders (the first and second cathode polymer), the cathode active material, the cathode conductive material and the solvent are blended together to form the cathode mixture, which is in the form of a slurry. This can occur in a single step or can first include an initial slurry of the cathode electrically conductive material and at least a portion of one of the cathode polymers which is then further mixed with the cathode active material and any remaining portion of the cathode polymer(s). The blending process facilitates dispersion of the cathode conductive material and the cathode active material to form a percolating network through the volume of the cathode active layer when the solvent is removed. In an embodiment, the cathode mixture (in slurry form) is disposed on a current collector after the mixing is completed. The current collector with the cathode mixture disposed thereon is subjected to shear and compression in a roll mill. The use of a roll mill facilitates bonding of the cathode active layer to the current collector.

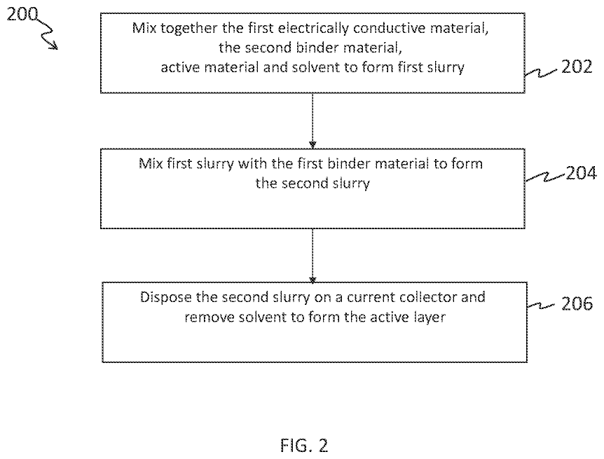

FIG. 2 is a flow chart of a method for making an electrode according to various embodiments. The description of process 600 is provided with respect to electrode 100 of FIG. 1. Referring to FIG. 2, in some embodiments, the active layer 106 of electrode 100 may be formed using process 600. As 610, high aspect ratio carbon elements and a surface treatment material (e.g., a surfactant or polymer material as described herein) are combined with a solvent (of the type described herein) to form an initial slurry.

At 620, the initial slurry is processed to ensure good dispersion of the solid materials in the slurry. In some embodiments, this processing includes introducing mechanical energy into the mixture of solvent and solid materials (e.g., using a sonicator, which may be sometimes also be referred to as a “sonifier”) or other suitable mixing device (e.g., a high shear mixer). In some embodiments, the mechanical energy introduced into the mixture is at least 0.4 kilowatt-hours per kilogram (kWh/kg), 0.5 kWh/kg, 0.6 kWh/kg, 0.7 kWh/kg, 0.8 kWh/kg, 0.9 kWh/kg, 1.0 kWh/kg, or more. For example, the mechanical energy introduced into the mixture per kilogram of mixture may be in the range of 0.4 kWh/kg to 1.0 kWh/kg or any subrange thereof such as 0.4 kWh/kg to 0.6 kWh/kg.

In some embodiments an ultrasonic bath mixer may be used. In other embodiments, a probe sonicator may be used. Probe sonication may be significantly more powerful and effective when compared to ultrasonic baths for nanoparticle applications. High shear forces created by ultrasonic cavitation have the ability to break up particle agglomerates and result in smaller and more uniform particles sizes. Among other things, sonication can result in stable and homogenous suspensions of the solids in the slurry. Generally, this results in dispersing and deagglomerating and other breakdown of the solids. Examples of probe sonication devices include the Q Series Probe Sonicators available from QSonica LLC of Newtown, Connecticut. Another example includes the Branson Digital SFX-450 sonicator available commercially from Thomas Scientific of Swedesboro, New Jersey.

In some embodiments, however, the localized nature of each probe within the probe assembly can result in uneven mixing and suspension. Such may be the case, for example, with large samples. This may be countered by use of a setup with a continuous flow cell and proper mixing. For example, with such a setup, mixing of the slurry will achieve reasonably uniform dispersion.

In some embodiments the initial slurry, once processed will have a viscosity in the range of 5,000 cps to 25,000 cps or any subrange thereof, e.g., 6,000 cps to 19,000 cps.

At 630, the surface treatment may be fully or partially formed on the high aspect ratio carbon elements in the initial slurry. In some embodiments, at this stage the surface treatment may self-assemble. The resulting surface treatment may include functional groups or other features which, as described in further steps below, may promote adhesion between the high aspect ratio carbon elements and active material particles.

At 640, the active material particles may be combined with the initial slurry to form a final slurry containing the active material particles along with the high aspect ratio carbon elements with the surface treatment formed thereon.

In some embodiments, the active material may be added directly to the initial slurry. In other embodiments, the active material may first be dispersed in a solvent (e.g., using the techniques described above with respect to the initial solvent) to form an active material slurry. This active material slurry may then be combined with the initial slurry to form the final slurry.

At 650, the final slurry is processed to ensure good dispersion of the solid materials in the final slurry. In various embodiments any suitable mixing process known in the art may be used. In some embodiments this processing may use the techniques described above with reference to 620. In some embodiments, a planetary mixer such as a multi-axis (e.g., three or more axis) planetary mixer may be used. In some such embodiments the planetary mixer can feature multiple blades, e.g., two or more mixing blades and one or more (e.g., two, three, or more) dispersion blades such as disk dispersion blades.

In some embodiments, during 650, the matrix enmeshing the active material may fully or partially self-assemble. In some embodiments, interactions between the surface treatment and the active material promote the self-assembly process.

In some embodiments the final slurry, once processed will have a viscosity in the range of 1,000 cps to 10,000 cps or any subrange thereof, e.g., 2,500 cps to 6000 cps

At 660, the active layer 106 is formed from the final slurry. In some embodiments, final slurry may be cast wet directly onto the current collector conductive layer 102 (or optional adhesion layer 104) and dried. As an example, casting may be by applying at least one of heat and a vacuum until substantially all of the solvent and any other liquids have been removed, thereby forming the active layer 106. In some such embodiments, protecting various parts of the underlying layers may be desirable. For example, protecting an underside of the conductive layer 102 may be desirable where the electrode 100 is intended for two-sided operation. Protection may include, for example, protection from the solvent by masking certain areas, or providing a drain to direct the solvent away.

In other embodiments, the final slurry may be at least partially dried elsewhere and then transferred onto the adhesion layer 104 or the conductive layer 102 to form the active layer 106, using any suitable technique (e.g., roll-to-roll layer application). In some embodiments the wet combined slurry may be placed onto an intermediate material with an appropriate surface and dried to form the layer (e.g., the active layer 106). While any material with an appropriate surface may be used as the intermediate material, exemplary intermediate material includes PTFE as subsequent removal from the surface is facilitated by the properties thereof. In some embodiments, the designated layer is formed in a press to provide a layer that exhibits a desired thickness, area and density.

In some embodiments, the final slurry may be formed into a sheet, and coated onto the adhesion layer 104 or the conductive layer 102 as appropriate. For example, in some embodiments, the final slurry may be applied to through a slot die to control the thickness of the applied layer. In other embodiments, the slurry may be applied and then leveled to a desired thickness, e.g., using a doctor blade. A variety of other techniques may be used for applying the slurry. For example, coating techniques may include, without limitation: comma coating; comma reverse coating; doctor blade coating; slot die coating; direct gravure coating; air doctor coating (air knife); chamber doctor coating; off set gravure coating; one roll kiss coating; reverse kiss coating with a small diameter gravure roll; bar coating; three reverse roll coating (top feed); three reverse roll coating (fountain die); reverse roll coating and others.

The viscosity of the final slurry may vary depending on the application technique. For example, for comma coating, the viscosity may range between about 1,000 cps to about 200,000 cps. Lip-die coating provides for coating with slurry that exhibits a viscosity of between about 500 cps to about 300,000 cps. Reverse-kiss coating provides for coating with slurry that exhibits a viscosity of between about 5 cps and 1,000 cps. In some applications, a respective layer may be formed by multiple passes.

In some embodiments, the active layer 106 formed from the final slurry may be compressed (e.g., using a calendaring apparatus) before or after being applied to the electrode 100. In some embodiments, the slurry may be partially or completely dried (e.g., by applying heat, vacuum or a combination thereof) prior to or during the compression process. For example, in some embodiments, the active layer may be compressed to a final thickness (e.g., in the direction normal to the current collector layer 102) of less than 90%, 80%, 70%, 50%, 40%, 30%, 20%, 10% or less of its pre-compression thickness.

In various embodiments, when a partially dried layer is formed during a coating or compression process, the layer may be subsequently fully dried, (e.g., by applying heat, vacuum or a combination thereof). In some embodiments, substantially all of the solvent is removed from the active layer 106.

In some embodiments, solvents used in formation of the slurries are recovered and recycled into the slurry-making process.

In some embodiments, active layer 106 may be compressed, e.g., to break some of the constituent high aspect ratio carbon elements or other carbonaceous material to increase the surface area of the respective layer. In some embodiments, this compression treatment may increase one or more of adhesion between the layers, ion transport rate within the layers, and the surface area of the layers. In various embodiments, compression can be applied before or after the respective layer is applied to or formed on the electrode 100.

In some embodiments where calendaring is used to compress active layer 106, the calendaring apparatus may be set with a gap spacing equal to less than 90%, 80%, 70%, 50%, 40%, 30%, 20%, 10% or less of the layer's pre-compression thickness (e.g., set to about 33% of the layer's pre-compression thickness). The calendar rolls can be configured to provide suitable pressure, e.g., greater than 1 ton per cm of roll length, greater than 1.5 ton per cm of roll length, greater than 2.0 ton per cm of roll length, greater than 2.5 ton per cm of roll length, or more. In some embodiments, the post compression active layer will have a density in the range of 1 g/cc to 10 g/cc, or any subrange thereof such as 2.5 g/cc to 4.0 g/cc. In some embodiments the calendaring process may be carried out at a temperature in the range of 20° C. to 140° C. or any subrange thereof. In some embodiments active layer 106 may be pre-heated prior to calendaring, e.g., at a temperature in the range of 20° C. to 100° C. or any subrange thereof.

Once the electrode 100 has been assembled, the electrode 100 may be used to assemble the energy storage device. Assembly of the energy storage device may follow conventional steps used for assembling electrodes with separators and placement within a housing such as a canister or pouch, and further may include additional steps for electrolyte addition and sealing of the housing.

In various embodiments, process 600 may include any of the following features (individually or in any suitable combination)

In some embodiments, the initial slurry has a solid content in the range of 0.1%-20.0% (or any subrange thereof) by weight. In some embodiments, the final slurry has a solid content in the range of 10.0%-80% (or any subrange thereof) by weight.

The 3D carbon scaffold or matrix holds active material particles together to form a cohesive layer that is also strongly attached to the metallic current collector. Such active material structure is created during slurry preparation and subsequently in a roll to roll (“R2R”) coating and drying process. One of the main advantages of this technology is its scalability and “drop-in” nature because various embodiments are compatible with conventional electrode manufacturing processes.

The 3D carbon matrix is formed during a slurry preparation using the techniques described herein: high aspect ratio carbon materials are properly dispersed and chemically functionalized using, e.g., a 2-step slurry preparation process (such as the type described above with reference to process 600 of FIG. 2). The chemical functionalization is designed to form an organized self-assembled structure with the surface of active material particles, e.g. NMC particles for use in a cathode or silicon particles (“Si”) or Silicon Oxide (“SiOx”) particles in the case of an anode. The so formed slurry may be based on water and/or alcohol solvents for cathodes and water for anodes, and such solvents are very easily evaporated and handled during the manufacturing process. Electrostatic interactions promote the self-organized structure in the slurry, and after the drying process the bonding between the so formed carbon matrix with active material particles and the surface of the current collector is promoted by the surface treatment (e.g., functional groups on the matrix) as well as the strong entanglement of the active material in the carbon matrix.

As will be understood by one skilled in the art, the mechanical properties of the electrodes can be readily modified depending on the application, and the mass loading requirements by tuning the surface functionalization vs. entanglement effect.

After coating and drying, the electrodes undergo a calendaring step to control the density and porosity of the active material. In NMC cathode electrodes, densities of 3.5 g/cc or more and 20% porosity or more can be achieved. Depending on mass loading and LIB cell requirements the porosity can be optimized. As for SiOx/Si anodes, the porosity is specifically controlled to accommodate active material expansion during the lithiation process.

In some typical applications, the teachings herein may provide a reduction in $/kWh of up to 20%. By using friendly solvents that are easily evaporated, the electrode throughput is higher, and more importantly, the energy consumption from the long driers is significantly reduced. The conventional NMP recovery systems are also much simplified when alcohol or other solvent mixtures are used.

The teachings herein provide a 3D matrix that dramatically boosts electrode conductivity by a factor of 10× to 100× compared to electrodes using conventional binders such as PVDF, which enables fast charging at a battery level. Thick electrode coatings in cathode up to 150 μm per side (or more) of current collector are possible with this technology. The solvents used in the slurry in combination with a strong 3D carbon matrix are designed to achieve thick wet coatings without cracking during the drying step. Thick cathodes with high capacity anodes are what enable a substantial jump in energy density reaching 400 Wh/kg or more.

One exemplary embodiments includes a Li-ion battery energy storage devices in a pouch cell format that combines Ni-rich NMC active material in the cathodes and SiOx and graphite blend active material in the anodes, where both anodes and cathodes are made using a 3D carbon matrix process as described herein.

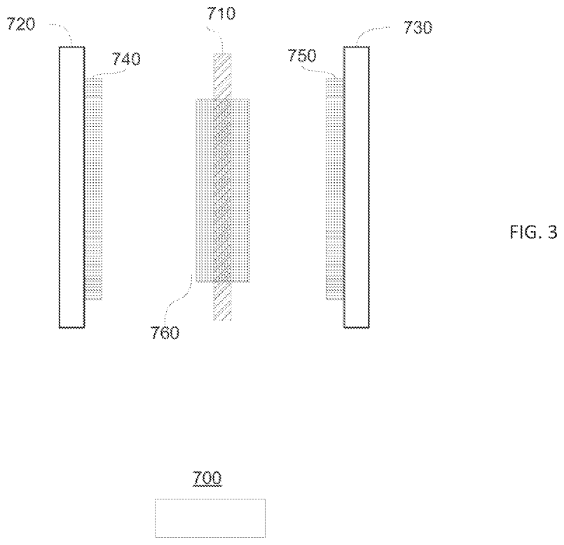

A schematic of the electrode arrangement pouch cell devices is shown in FIG. 3. As shown, a double-sided cathode 700 using cathode layers 760 (e.g., active layers according to various embodiments disclosed herein) on opposing sides of an aluminum foil current collector 710 are disposed between two single sided anodes 720 and 730 each having an anode layer 740 and 750 (e.g., an active layer comprising a network of carbon elements such as disclosed herein) disposed on a copper foil current collector. The electrodes are be separated by permeable separator material (not shown) wetted with electrolyte (not shown). The arrangement can be housed in a pouch cell of the type well known in the art.

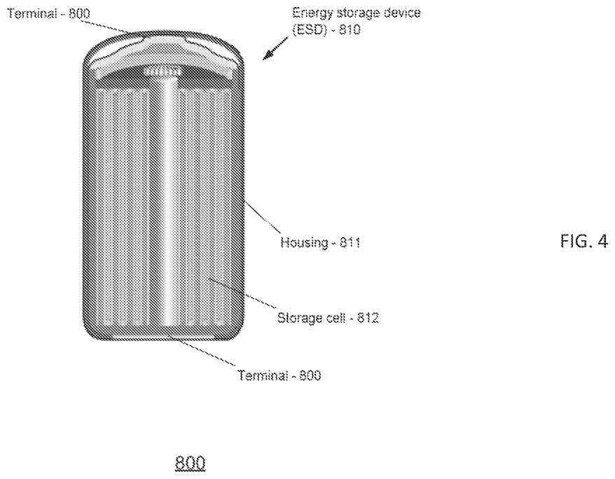

In FIG. 4, a cross section of an energy storage device (ESD) 810 is shown. The energy storage device (ESD) 810 includes a housing 811. The housing 811 has two terminals 800 disposed on an exterior thereof. The terminals 800 provide for internal electrical connection to a storage cell 812 contained within the housing 811 and for external electrical connection to an external device such as a load or charging device (not shown). The energy storage devices disclosed herein may be batteries, capacitors, ultracapacitors, or the like.

The materials and the structures disclosed herein are exemplified by the following non-limiting examples.

### EXAMPLES

This is a prophetic example that depicts how the active anode materials can be manufactured.
An anode can be formed from the following materials:

SiO—C at 27 to 31 weight percent (wt. %), and artificial graphite at 1 to 5 wt % may be used as the anode active materials. A polyacrylic acid polymer at 2.2 to 2.7 wt. %, and carboxymethylcellulose at 0.1 to 0.5 wt. % may be used as the anode binder polymers. Single wall carbon nanotubes at 0.0875 to 0.175 wt %, multiwall carbon nanotubes at 0.35 to 0.4375 weight percent may be used as the electrically conductive material. A water/ethanol (90/10 weight ratio) solvent making up the balance to yield 100% to form the slurry. The slurry can be prepared and mixed as described above and coated onto a current collector and dried to form an anode.

A cathode can be formed from the materials:

About 64 wt % Ni-rich NMC is used as the cathode active material. Polyamide or polyacrylic acid polymer at 0.1625 to 0.325 wt %. and polyvinylpyrrolidone at 0.1625 to 0.325 wt % are used as the cathode polymer binder. Multiwall carbon nanotubes are to be used in an amount of 0.325 wt % as the cathode conductive material. Ethanol may be used as the solvent to make up the balance of the slurry. The slurry can be prepared and mixed as described above and coated onto a current collector and dried to form the cathode.

While the invention has been described with reference to some embodiments, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiments disclosed as the best mode contemplated for carrying out this invention, but that the invention will include all embodiments falling within the scope of the appended claims.

1. An electrode, comprising:
an active layer comprising:
a network of high aspect ratio carbon elements defining void spaces within the network;
a plurality of electrode active material particles disposed in the void spaces within the network; and
a polymeric binder comprising a first polymer which comprises an acid functional group or a salt of such acid functional group; a polyamide; or an acrylate polymer, and a second polymer.

2. The electrode of claim 1, wherein network of high aspect ratio carbon elements comprises:
a first set of carbon nanotubes, wherein the first set of carbon nanotubes comprises a plurality of first carbon nanotubes or a plurality of bundles of first carbon nanotubes; and
a second set of carbon nanotubes, wherein:
the second set of carbon nanotubes comprise a plurality of second carbon nanotubes or a plurality of bundles of second carbon nanotubes; and
the second set of carbon nanotubes has one or more properties different from the first set of carbon nanotubes.

3. The electrode of claim 2, wherein the first set of carbon nanotubes comprises single wall carbon nanotubes.

4. The electrode of claim 2, wherein the second set of carbon nanotubes comprises multiwall carbon nanotubes.

5. The electrode of claim 2, wherein:
the first set of carbon nanotubes comprises single wall carbon nanotubes;
the second set of carbon nanotubes comprises multi-wall carbon nanotubes; and
a ratio of an amount by weight of the first set of carbon nanotubes to the second set of carbon nanotubes is about 2:1.

6. The electrode of claim 1, wherein the network of high aspect ratio carbon elements comprises a set of multi-wall carbon nanotubes, preferably 0.8 to 2.6, more preferably between 1 and 1.8 wt % of multi-wall carbon nanotubes by weight of the active layer.

7. The electrode of claim 3, wherein the active layer comprises between 0.2 and 0.6, preferably between 0.3 and 0.5, wt % of single wall carbon nanotubes by weight of the active layer.

8. The electrode of claim 1 wherein the second polymer comprises polyvinyl pyrrolidone or a cellulose polymer.

9. An energy storage device comprising:
an electrolyte; and
the electrode of claim 5.

10. The energy storage device of claim 9, wherein the multi-wall nanotubes swell more than the single-wall carbon nanotubes when wetted with the electrolyte.

11. The electrode of claim 5, wherein the multi-wall carbon nanotubes comprise:
an average diameter of between 6 nm and 10 nm;
an average wall thickness of between 6 nm and 7 nm; and
an average length of about 10 nanometers to 20 micrometers.

12. The electrode of claim 5, wherein the single-wall carbon nanotubes comprise:
an average diameter of between 0.5 nm and 5 nm;
and an average length of about 10 nm to 20 micrometers.

13. The electrode of claim 5, wherein the single-wall carbon nanotubes comprise:
an average diameter of between 3 nm and 5 nm; and
an average length of at least 200 micrometers.

14. The electrode of claim 5, wherein after wetted with an electrolyte an average thickness of the electrode increases by less than 10%.

15. The electrode of claim 5, wherein an average aspect ratio of the second set of carbon nanotubes is larger than an average aspect ratio of the first set of carbon nanotubes.

16. An energy storge device comprising:
a housing;
an electrolyte;
a first current collector;
an anode active material disposed on the first current collector; where the anode active material comprises a network of high aspect ratio carbon elements defining void spaces within the network;
a plurality of anode active material particles disposed in the void spaces within the network; and
an anode polymeric binder, the polymeric binder comprising a first polymer which is a polymer comprising an acid functional group or a salt of such acid functional group or an acrylate polymer; and
a second current collector;
a cathode active material disposed on the second current collector; where the cathode active material comprises a network of high aspect ratio carbon elements defining void spaces within the network;
a plurality of cathode active material particles disposed in the void spaces within the network; where the cathode active material comprises a combination of nickel, manganese and cobalt; and
a cathode polymeric binder, the polymeric binder comprising a first polymer which is a polymer comprising an acid functional group or a salt of such acid functional group; a polyamide; or an acrylate polymer,
wherein at least one of the anode polymeric binder and the cathode polymeric binder further comprise a second polymer.

17. The energy storage device of claim 16, wherein the anode polymeric binder comprises a second polymer, preferably a cellulose polymer, more preferably carboxymethyl cellulose.

18. The energy storage device of claim 16, wherein the cathode polymeric binder comprises a second polymer.

19. The energy storage device of claim 18, wherein the second polymer is polyvinylpyrollidone.

20. The electrode of claim 12, wherein the single-wall carbon nanotubes comprise an average diameter of between 3 and 5 nm and an average length of about 7 to 8 micrometers.
